(19) United States
(12) Patent Application Publication
(10) Pub. No.: US 2016/0245394 A1
(43) Pub. Date: Aug. 25, 2016

(54) COUPLING ELEMENT FOR A SHIFTING CARRIAGE, SHIFTING CARRIAGE, AND METHOD FOR MOUNTING A GEAR SELECTION LEVER ON A SHIFTING CARRIAGE

(71) Applicant: ZF FRIEDRICHSHAFEN AG, Friedrichshafen (DE)

(72) Inventor: Jan Szekeres-Kriselius, Lemförde (DE)

(73) Assignee: ZF Friedrichshafen AG, Friedrichshafen (DE)

(21) Appl. No.: 15/027,662

(22) PCT Filed: Sep. 10, 2014
(86) PCT No.: PCT/EP2014/069243

§ 371 Date: Apr. 6, 2016

(30) Foreign Application Priority Data
Oct. 10, 2013 (DE) 102013220408.6

(51) Int. Cl. F16H 59/04

(52) U.S. Cl. CPC F16H 59/042

(57) ABSTRACT

The current embodiments provide a coupling element for a shift lever for a vehicle transmission. The coupling element may include a passage for receiving a section of the shift lever and a ring with a bore configured to receive the section of the shift lever. The ring may be installed in a ring holder of the passage, where the ring holder is configured to pivotally hold the ring.

The currently embodiments relate to a coupling element for a shift carriage for switch-effective transfer of a pivotal movement of a shift lever of a vehicle transmission, in particular a motor vehicle automatic transmission, a shift carriage and a method for mounting a shift lever to a shift carriage.

The applicant's published patent application DE 102 52 009 A1 relates to a shift lever device for transmitting gears selectable by means of a shift lever to a vehicle transmission. The shift lever device includes a shift lever pivoting along a selection axis and a shift axis, which engages with one end in a shift carriage to forcibly move it. The shift carriage is mechanically connected, for example by means of a simple cable, a Bowden cable or a mechanical linkage, with the vehicle transmission with switching effect. The shift lever has along its longitudinal axis two spherical means of different sizes mounted by a plastic extrusion, wherein the larger spherical member forms a shift lever bearing in the shift lever device, around which the shift lever is pivotable. The smaller ball element couples the shift lever with the shift carriage for forcible entrainment of the same. Upon movement of the shift lever, the smaller ball element thus follows a spherical orbit around the selector bearing. To compensate for the spherical orbital motion, a spherical shell-like engagement is provided, which is engageable with the smaller spherical ball element. The shift carriage has a receptacle for receiving the ball cup-like engagement in the engaged state with the smaller spherical element and the shift lever.

The aforementioned solution is disadvantageous in that a variable distance between the two spherical elements requires a change of the corresponding injection mold tool for encapsulation of the shift lever or alternatively requires change adapters. Furthermore, an assembly of the mentioned shift lever device is relatively expensive. This is so because first, the cup-like engagement must be applied onto the smaller spherical element mounted on the shift lever, whereby the cup-like element can be undefined in its angular position. During the subsequent introduction of the shift lever with the applied cup-like element into the shift carriage, this undefined position can lead to the need to initially align the cup-like element.

The current embodiments provide a coupling element for a shift carriage and a shift carriage for switch-effective transfer of a pivotal movement of a shift lever of a vehicle transmission, which in particular allows a simple mounting of the shift lever on the shift carriage and can be used for different shift levers. The current embodiments also provide a method of mounting a shift lever to a coupling element for a shift carriage forcedly movable by the shift lever.

According to one aspect, a coupling element for a shift carriage for a switch-effective transfer of a pivotal movement of a shift lever to a vehicle transmission is proposed. Under a switch-effective transmission or connection within the meaning of this disclosure is to be understood such a transfer or connection, in which by a pivotal movement of the shift lever by means of forcibly moving the shift carriage, such a power transfer in the direction of the vehicle transmission takes place that a shifting operation of the vehicle transmission corresponding to the shift lever position can be carried out. A selectable gear can be, for example, park position P, neutral N, reverse operation R, drive or forward drive D or another switching gear executable in an automatic transmission.

The proposed coupling element includes a passage for receiving a section of the shift lever. The coupling element may be preferably made of a plastic-containing material by means of an injection molding process. In this manner, a coupling element adapted to the actual need can be inexpensively manufactured. More preferably, the coupling element is formed integrally with a shift carriage e.g. by means of the injection molding process.

The coupling element is characterized in that it comprises a ring with a bore into which the shift lever portion can be introduced, wherein the ring is inserted into a holder in the passage formed for pivotally holding the ring. Thus, in contrast to prior art, a gating of the spherical member to the shift lever can be omitted. In contrast, a ring with a bore to be initially introduced into the passage or the ring holder is provided, in which bore the shift lever section can subsequently be installed. The ring is pivotable in the ring holder and is held at the same time by means of the ring holder in the passage. This allows accommodating different length variants of the shift lever with the same coupling element. Further, in case of need the shift lever need only be provided with plastic extrusion constituting the shift lever bearing. Furthermore, an assembly of the shift lever to the coupling element or to the shift carriage is possible in a simple manner.

Preferably, the ring bore is formed such that the shift lever section is slidably or freely movable in the ring bore. In other words, the ring bore is preferably formed such that the shift lever section can be arranged in the ring bore movable relative to the ring. For the purposes of this disclosure, a slidably movable arrangement is such an arrangement of two components, in which the one component rests against the other component and is movable along the other component at least partially on full circumference. Applied to the preferred embodiment, the ring bore comprises, under consideration of appropriate tolerances such as the aforementioned tolerances, an internal dimension corresponding to the outer dimension of the shift lever section. In contrast, a freely movable arrangement of two components corresponds to an arrangement at a distance from each other with some play. For the alternatively preferred embodiment, this means that an internal dimension of the ring bore corresponds to an outer dimension of the shift lever section plus a predetermined play. This allows the readjustment of a shift carriage route and an adequate distance between the holder of the shift lever section in the coupling element and the shift lever bearing. Such re-adjustment can be required, for example, for shift lever rods of different lengths and shift path features.

According to another preferred embodiment, the coupling element has in the region of the ring holder a stop which is adapted to cooperate with a counter stop, which is fixedly connected to the ring for limiting a pivot angle of the ring. For this purpose, on the one hand, the mounting of the shift lever in the shift carriage can be simplified, on the other hand, the limitation of the pivot angle and thus a limitation of the pivoting range of the shift lever in the received state of the same is possible in a simple manner.

According to another preferred embodiment, the ring is formed of a ball ring, wherein the ring holder has a spherical shell-like inner surface complementary to an outer surface of the ball ring. This can ensure a spherical bearing of the ring in the passage, whereby a shift lever movement parallel to a passage plane through the ring bore in every direction is made possible. An outside radius forming the outer surface of the spherical ring and the inner radius forming the spherical shell-like inner surface of the ring holder are preferably selected such that the spherical ring is snapped into the ring holder. By means of this type of fixing and mounting the ball ring in the ring holder, the ball ring can, on the one hand, be held by the ring holder and, on the other hand, be pivoted in the ring holder. The snapping-in and holding properties can be further facilitated by a preferred plastic-containing formation at least of the ring holder and more preferably of the ball ring.

In an alternative embodiment, the ring has a cross-sectionally concave outer surface, wherein the ring holder has a cross-sectionally circular-segment-like convex inner surface complementary to the concave outer surface. In other words, the ring has along its outer periphery a dome pointing to the ring center, whereas the ring holder has a bulge complementary to the convex ring inner surface and extending along the ring holder periphery.

According to another preferred embodiment, starting from the ring holder, the passage is formed funnel-like widening. More preferably, the funnel shape is selected such that a passage edge limiting the funnel forms a stop for the shift lever. Thus, a pivoting range of the shift lever can be adapted according to requirements taking into account the shift carriage path.

The funnel has in a plan view preferably a circular shape. The funnel or the passage may, however, assume any conceivable geometric shape so long as the coupling element or the coupling ring can be pivotally held in the ring holder of the passage and the passage allows a pivotal movement of the shift lever in at least one direction. Further, according to a preferred embodiment, the funnel and the ring holder can have mutually different geometrical forms. For example, the funnel can be designed polygonal, in particular rectangular or square, while the ring holder is circular.

According to another aspect, a method is proposed of mounting, by means of a coupling element, a shift lever to a shift carriage which is forcedly moved by the shift lever. The shift carriage is adapted for switch-effective transfer of a pivotal movement of the shift lever to a vehicle transmission. The method includes a step of placing a ring with a bore into a recess formed in a passage of the coupling element for pivotally supporting the ring, and a subsequent step of introducing a section of the shift lever in the ring hole. The aforementioned components are preferably the corresponding components described above.

According to a preferred embodiment, the coupling element forms a component separate from the shift carriage which is connectable to the shift carriage to form a common component, wherein the method comprises a further step of mounting the coupling element to the shift carriage. The assembly step can be optionally carried out before, between or after the two aforementioned installing steps. For reasons of ease of assembly, it is particularly preferred to carry out the assembly step between the two installing steps.

Alternatively, the coupling element can be formed integrally with the shift carriage. Within the meaning of this disclosure, integral form design requires a common formation of the shift carriage with the coupling element, as it can be achieved for example by injection molding. Due to the one-piece molding, the proposed assembly process can be further simplified. Furthermore, a component is omitted, whereby production costs can be saved.

Further features and advantages will become apparent from the following description of preferred embodiments, with reference to the figures and drawings, and from the claims. The individual features can be realized each individually or jointly in any combination.

The preferred embodiments will be explained in more detail with reference to the accompanying drawings. The drawings show:

FIG. 1 shows a top perspective view of a coupling element according to a preferred embodiment.

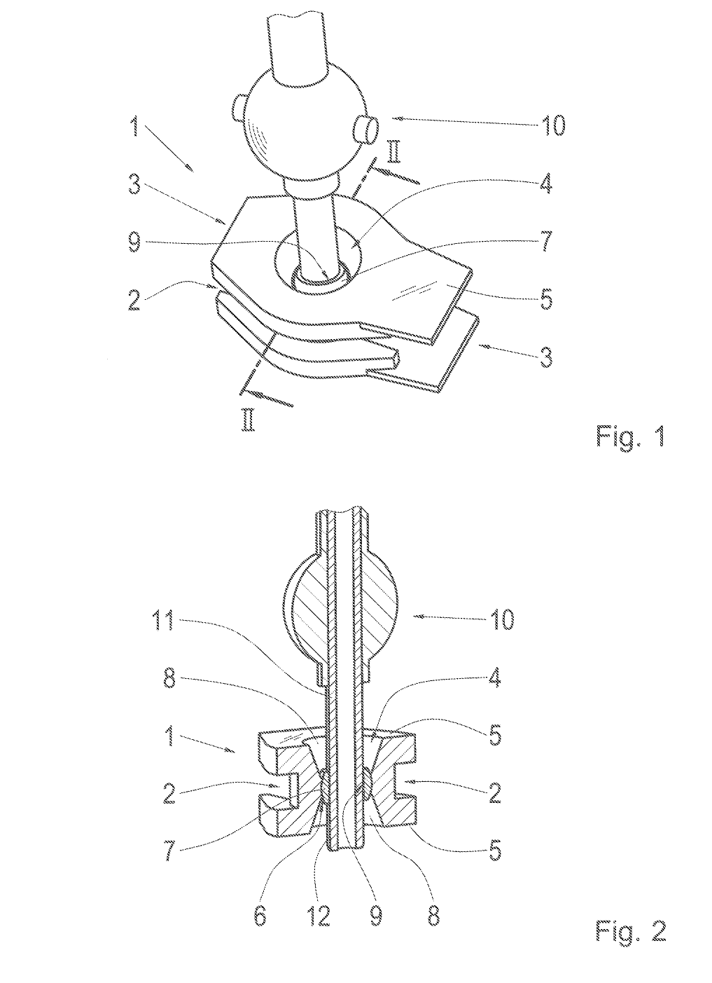

FIG. 2 shows a sectional view of the coupling element shown in FIG. 1.

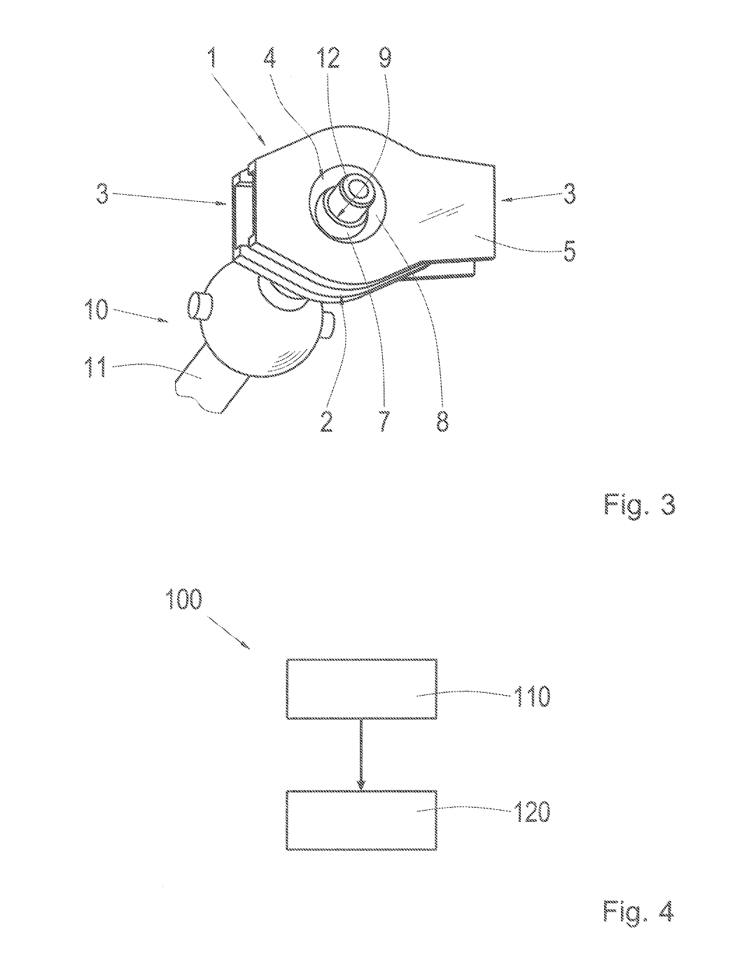

FIG. 3 is a perspective view of the coupling element shown in FIG. 1; and

FIG. 4 is a flow diagram of a method of assembling a shift lever to a shift carriage by means of a coupling element according to a preferred embodiment.

FIG. 1 shows a top perspective view of a coupling element 1 according to a preferred embodiment. The coupling element 1 is formed of a material containing plastic by means of an injection molding process. The coupling element 1 (FIG. 2) is designed mirror-symmetrically to two of its mutually orthogonal center planes. The coupling element 1 is adapted to be inserted and connected in a shift carriage (not shown) for a vehicle transmission shift lever device, wherein the shift carriage is provided for the switch-effective transfer of a pivotal movement of a shift lever 10 of the shift lever device to a vehicle transmission. The coupling element 1 allows a forced movement of the shift carriage by the shift lever 10.

The coupling element 1 has in cross-section approximately a double-T shape, whereby on opposite longitudinal sides is formed in each case an engagement groove 2 for engagement with an engagement spring of the shift carriage. The engagement grooves 2 are arranged between the front ends 3 of the coupling element, wherein the front ends 3 are set up such that the coupling element 1 can be inserted into the shift carriage and fastened therewith. Alternatively, the coupling element 1 itself can form the shift carriage, wherein at the front ends 3 a device is provided by means of which a linear movement of the coupling element can be transferred with switch effect to a motor vehicle device. This can be realized for example by connecting a power transmission device to a front end 3 of the coupling element 1 as in the prior art described at the outset.

The coupling element 1 comprises a passage 4, which connects the surface sides 5 of the double T-shaped coupling element 1 facing away from each together. FIG. 2 shows a sectional view of the passage 4 along the section line II-II shown in FIG. 1. FIG. 2 illustrates the double-T-shape of the coupling element 1 and shows in detail the design of the passage 4. The passage 4 comprises a middle section lying in a plane of symmetry of the coupling element 1, a spherical ring 6, which holds a pivotable spherical ring 7. From the ring holder 6, the passage 4 is extending funnel-like widening up to the respective surface side 5. Thus are formed funnels 8 running away from each other, which are mirror symmetrical with respect to the plane of symmetry of the coupling element which at least partly surrounds the ring holder 6. An opening width of the funnel 8 or the angle formed between the funnel 8 and the symmetry plane, which at least partially surrounds the ring holder 6, is selected such that the shift lever 10 piercing the spherical ring 7 is freely pivotable within a predetermined pivot angle range, which can be defined by a predetermined, freely selectable gear arrangement selectable by means of the shift lever 10. Preferably, the opening width of the funnel 8 or the angle between the funnel 8 and the plane of symmetry at least partially surrounding the ring holder 6 can be selected such that the shift lever 10 in at least one predetermined shift lever position, which may correspond to a selectable gear, in system comes in contact with an edge of the funnel 8, whereby a stop is formed for the pivotal shift lever 10.

The ring holder 6 and the funnel 8 continuing from the ring holder 6 form the passage 4 with the shape of a hourglass, wherein the ring holder 6 constitutes the middle, constricted section of the hourglass shape. The ring holder 6 has on a side facing the center axis of the passage 4 a spherical shape-like form. In other words, a surface side of the ring holder 6, which forms a part of the inner surface of the passage 4, is formed over a predetermined radius outgoing from the center axis of the passage 4. Thus, in cross-section the ring holder 6 has a concave shape. The cross-sectionally concave shape, or the spherical shell-like configuration of the ring holder 6 is designed complementary to an outer surface of the spherical ring arranged in the ring holder 6. In other words, the ring holder 6 forms a negative form of the outer surface of the spherical ring 7.

The mutually complementary surfaces of the ring holder 6 and the spherical ring 7 are such that the spherical ring 7 can be snapped by a certain force into the ring holder 6. Due to this design, the spherical ring 7 can be held in the ring holder 6 and, due to the complementary configuration of the respective surfaces of the ring holder 6 and the spherical ring 7, can move or pivot relative to the ring holder 6.

The spherical ring 7 comprises a central cylindrical bore 9 for receiving a section of the shift lever 10. The shift lever 10 is composed of a cross-sectionally circular shift lever rod 11, which can be installed with one of its free ends 12 in the bore 9 of the spherical ring 7. The inner diameter of the bore 9 can be selected such that a relative movement of the shift lever rod 11 to the spherical ring 7 is possible unhindered or almost unhindered. An unhindered relative movement of the shift lever rod 11 to the spherical ring 7 can be achieved in that the inner diameter of the bore 9 is, considering tolerances, such as manufacturing tolerance and component tolerances, greater than an outer diameter of the shift lever rod 11. An almost unhindered relative movement can for example be achieved in that the internal diameter of the bore 9 is selected such that the spherical ring 7 comes in sliding contact with the shift lever rod 11 including the tolerances, such as the aforementioned tolerances.

FIG. 4 shows a flow diagram of a method 100 for mounting a shift lever of a shift lever device to a shift carriage by means of a coupling element according to a preferred embodiment. The method includes a step 110 of placing a ring with a bore into a holder formed in a passage of the coupling element for pivotal supporting of the ring. This step is followed by a step 120 of placing a section of the shift lever in the ring bore. The second installation step 120 can immediately follow the first installation step 110. Alternatively, intermediate steps to adapt the method can be provided. For example, if the coupling element constitutes a component separate from the shift carriage, a mounting step can be provided, with which the coupling element is mountable on the shift carriage. However, the assembly step is not necessarily provided between the first and second installation steps. The assembly step may be alternatively carried out before the first or after the second installation step.

The shift lever, the shift carriage, the coupling element and the ring can be one of the above components.

By means of the preferred embodiments, a spherical coating of the shift lever can be omitted. Further, the shift lever can be more easily installed in the shift carriage, because a possible misalignment of the shift lever with the shift carriage coupling element and an accompanying previous alignment can be omitted. Furthermore, a distance between the shift lever bearing and the coupling point with the shift carriage can be adjusted as needed or easily varied.

The embodiments described and shown in the figures are chosen only by way of example. Different embodiments can be fully combined without regard to individual characteristics. An embodiment can also be supplemented by one or more features of another embodiment. The dimensions of the geometric shape of the elements described above are only exemplary and can be adjusted accordingly.

### REFERENCE NUMERALS

1 Coupling element
2 Guide groove
3 Front end
4 Passage
5 Surface side
6 Ring holder
7 Spherical ring
8 Funnel
9 Bore
10 Shift lever
11 Shift lever rod
12 Free end of the lever rod
100 Method
110 First installation step
120 Second installation step

1. A coupling element for a shift lever for a vehicle transmission, the coupling element comprising:
a passage for receiving a section of the shift lever, and
a ring with a bore configured to receive the section of the shift lever,
wherein the ring is installed in a ring holder of the passage, the ring holder configured to pivotally hold the ring.

2. The coupling element of claim 1, wherein the bore is configured such that the section of the shift lever is slidingly or freely movable in the bore.

3. The coupling element of claim 1, further comprising a stop in the ring holder, wherein the stop is configured to cooperate with a counter-stop fixed to the ring for limiting a pivot angle of the ring.

4. The coupling element of claim 1, wherein the ring is a spherical ring, and wherein the ring holder has a spherical shell-like inner surface complementary to an outer surface of the ring.

5. The coupling element of claim 1, wherein the ring has a cross-sectionally concave outer surface, and wherein the ring holder has a cross-sectionally circular-segment-like inner surface complementary to the concave outer surface of the ring.

6. The coupling element of claim 1, wherein the passage includes a funnel-like widening extending from the ring holder.

7. A shift carriage for transferring a pivotal movement of a shift lever to a vehicle transmission, the shift carriage connected to the coupling element of claim 1.

8. The shift carriage of claim 7, wherein the shift carriage and the coupling element are formed integrally.

9. A method for mounting a shift lever to a shift carriage, wherein a coupling element of the shift carriage is movable by the shift lever, and wherein the shift carriage is configured for transferring a pivotal movement of the shift lever to a vehicle transmission, the method comprising:
installing a ring with a bore in a ring holder formed in a passage of the coupling element, the passage configured for pivotally supporting the ring, and
installing a section of the shift lever in the bore of the ring.

10. The method of claim 9, wherein the bore is configured such that the section of the shift lever is slidingly or freely movable in the bore.

11. The method of claim 9, wherein the coupling element includes a stop in the ring holder, and wherein the stop is configured to cooperate with a counter-stop fixed to the ring for limiting a pivot angle of the ring.

12. The method of claim 9, wherein the ring is a spherical ring, and wherein the ring holder has a spherical shell-like inner surface complementary to an outer surface of the ring.

13. The method of claim 9, wherein the ring has a cross-sectionally concave outer surface, and wherein the ring holder has a cross-sectionally circular-segment-like inner surface complementary to the concave outer surface of the ring.

14. The method of claim 9, wherein the passage includes a funnel-like widening extending from the ring holder.

15. An assembly, the assembly comprising:
a shift carriage for transferring a pivotal movement of a shift lever to a vehicle transmission; and
a coupling element, the coupling element including:
a passage for receiving a section of the shift lever, and
a ring with a bore configured to receive the section of the shift lever,
wherein the ring is installed in a ring holder of the passage, the ring holder configured to pivotally hold the ring

16. The assembly of claim 15, wherein the coupling element forms a component separate from the shift carriage which is connectable to the shift carriage to form a common component.

17. The assembly of claim 15, wherein the coupling element is formed integrally with the shift carriage.

18. The assembly of claim 17, wherein the coupling element and the shift carrier are formed by injection molding.

19. The assembly of claim 15, further comprising the shift lever, wherein the bore is configured such that the section of the shift lever is slidingly or freely movable in the bore.

20. The assembly of claim 15, further comprising a stop in the ring holder, and wherein the stop is configured to cooperate with a counter-stop fixed to the ring for limiting a pivot angle of the ring
